(19) United States
(12) Patent Application Publication
(10) Pub. No.: US 2012/0292993 A1
(43) Pub. Date: Nov. 22, 2012

(54) Energy Scavenging Power Supply

(75) Inventors: Cory J. Mettler, Brookings, SD (US); Chris A. Mouw, Brookings, SD (US); Scott J. Perlenfein, Brookings, SD (US); Jesse L. VanOverbeke, Arlington, SD (US); Ali Manesh, Chicago, IL (US)

(73) Assignee: AMERICAN SCIENCE AND TECHNOLOGY CORPORATION, Chicago, IL (US)

(21) Appl. No.: 13/112,255

(22) Filed: May 20, 2011

(51) Int. Cl. H02J 4/00

(52) U.S. Cl. 307/25; 307/18

(57) ABSTRACT

An energy scavenging power system and method may include an energy conversion system having at least one transducer configured to harvest energy, an energy management and storage system configured to store harvested energy; and a load regulation system configured to provide stored energy to power one or more low power-consumption loads. The energy management and storage system may include a start-up capacitor having a small capacitance to allow for quick charging and fast turn-on, a short term capacitor to provide energy to the load or loads once turned-on, and a long term capacitor having a large capacitance to provide for sustained energy delivery to the loads. The system also may include a common charging bus that receives energy from each transducer, conditioned if necessary, and which then determines the capacitor to which the energy should be delivered.

### BACKGROUND OF THE INVENTION

1. Field of the Invention

The present invention is directed generally to the field of energy harvesting and more particularly to an energy scavenging power supply intended to replace or supplement batteries as power supplies in low power electronic systems.

2. Description of the Related Art

Batteries are the common way of powering most electronic devices. However, they have significant draw backs including weight, limited shelf lives, limited energy capacity, sensitivity to temperature changes, and disposal hazards.

Energy harvesting is used to recover power that is otherwise dissipated or lost in a system or environment. For example, a sensor installed outdoors may collect heat energy on a summer day, and use of thermal energy harvesting can collect that energy for use by the sensor.

There are many examples of energy harvesting systems designed to power small electronic circuits. However, these systems typically utilize a single energy harvesting technique and are either only able to power the load while the energy is available or have large storage systems that require a significant amount of time to charge up before the load can be activated.

Therefore, there exists a need for a system that can collect energy from a variety of sources in order to increase the potential of energy harvesting, provide quick turn-on times, and yet be able to power the load for long periods of time when harvestable energy is scarce. The system also may reduce the need for batteries.

### SUMMARY OF THE INVENTION

In one aspect, an energy scavenging power system may comprise: an energy conversion system having at least one transducer configured to harvest energy; an energy management and storage system configured to store the harvested energy; and a load regulation system configured to provide the stored energy to power one or more loads; wherein the energy management and storage system comprises a start-up capacitor, a short term capacitor and a long term capacitor, the short term capacitor having a larger capacitance than the start-up capacitor and the long term capacitor having a larger capacitance than the short term capacitor. The system further may include a charging bus electrically coupled to the energy conversion system and the energy management and storage system, the charging bus providing energy to the energy management and storage system. The charging bus may include at least one of a low power bus, a low voltage bus, and a high power bus.

Each transducer may be electrically coupled to a signal conditioning circuit, the signal conditioning circuit regulating an output from the transducer to match a requirement for the charging bus. In addition, the energy management and storage system may include a plurality of control circuits configured to direct energy from the charging bus to the start-up capacitor, the short term capacitor, or the long term capacitor based on a predetermined rule set.

The start-up capacitor may be charged directly by the short term capacitor and the charging bus, the short term capacitor may be charged directly by the long term capacitor and the charging bus, and the long term capacitor is charged directly by the charging bus.

In another aspect, a low power energy scavenging system may comprise: a plurality of transducers configured to scavenge energy from one or more sources; a plurality of charging stages, each stage comprising at least one capacitor and at least one switching circuit, which may include a Schmitt trigger; and a charging bus configured to receive energy from the plurality of transducers and route the energy to the plurality of charging stages; wherein only one charging stage at a time receives energy from the charging bus; wherein each switching circuit includes a hysteresis to establish different turn on and turn off voltage points for the switching circuit; and wherein the system is configured to provide power to one or more low power consumption loads.

The plurality of charging stages may include a start-up stage, a short term stage, and a long term stage. The start-up stage may include a first capacitor comprising an electrolytic capacitor, the short term stage may include a second capacitor comprising an electrolytic capacitor or a supercapacitor, and the long term stage may include a third capacitor comprising at least one supercapacitor, where the first capacitor has a capacitance lower than a capacitance of said second capacitor; and where the second capacitor capacitance is lower than a capacitance of the third capacitor. If the third capacitor comprises a plurality of capacitors, those capacitors may be connected in parallel, and the capacitance of the third capacitor may be the aggregate capacitance of these capacitors.

In still another aspect, a process for scavenging and distributing small amounts of energy to one or more loads may include the steps of: harvesting energy using a plurality of transducers; conditioning the harvested energy to substantially match input requirements for a charging bus; and distributing energy from the charging bus to a start-up capacitor, a short term capacitor, and a long term capacitor; where the start-up capacitor is charged until substantially fully charged, the short term capacitor is charged until either substantially fully charged or until a charge level of the start-up capacitor drops below a predetermined value; and where the long term capacitor is charged until either substantially fully charged or until the start-up capacitor charge level drops below the predetermined value or until a charge level of the short term capacitor drops below a second predetermined value.

The distributing step may include the steps of charging the start-up capacitor with energy from the charging bus and the short term capacitor, charging the short term capacitor with energy from the charging bus and the long term capacitor; and charging the long term capacitor with energy from the charging bus. In addition, a capacitance of the short term capacitor may be at least an order of magnitude larger than a capacitance of the start-up capacitor, and a capacitance of the long term capacitor may be at least two orders of magnitude larger than the short term capacitor capacitance.

The process also may include the steps of switching the start-up capacitor, the short term capacitor, and the long term capacitor on and off depending on predetermined voltage levels; and evaluating a hysteresis at one or more of the start-up capacitor, the short term capacitor, and the long term capacitor to determine whether each capacitor is charging or discharging. These switching and evaluating steps are accomplished using a separate switching circuit for each of capacitor, and at least one of the switching circuits may include a Schmitt trigger.

These and other features and advantages are evident from the following description, with reference to the accompanying drawings.

### BRIEF DESCRIPTION OF THE SEVERAL VIEWS OF THE DRAWINGS

FIG. 1 is a block diagram of an energy scavenging power system.

FIG. 2 is an example of an energy scavenging power system implemented in a weapons system.

FIG. 3 is a schematic diagram of one embodiment of an energy conversion system used with an energy scavenging power system.

FIG. 4 is a schematic diagram of one embodiment of an energy management and storage system used with an energy scavenging power system.

FIG. 5 is a schematic diagram of one embodiment of a load regulation system used with an energy scavenging power system.

FIG. 6 is a circuit diagram of one embodiment of a low power generation bus usable in the energy conversion system of FIG. 3.

FIG. 7 is a circuit diagram of one embodiment of a low voltage bus or harvest control usable in the energy conversion system of FIG. 3.

FIG. 8 is a circuit diagram of one embodiment of a high power generation bus usable between the energy conversion system of FIG. 3 and the energy management and storage system of FIG. 4.

FIG. 9 is a circuit diagram of one embodiment of short term storage and short term control components usable in the energy management and storage system of FIG. 4.

FIG. 10 is a circuit diagram of one embodiment of long term storage and long term control components usable in the energy management and storage system of FIG. 4.

FIG. 11 is a circuit diagram of one embodiment of a long term boost usable in the energy management and storage system of FIG. 4.

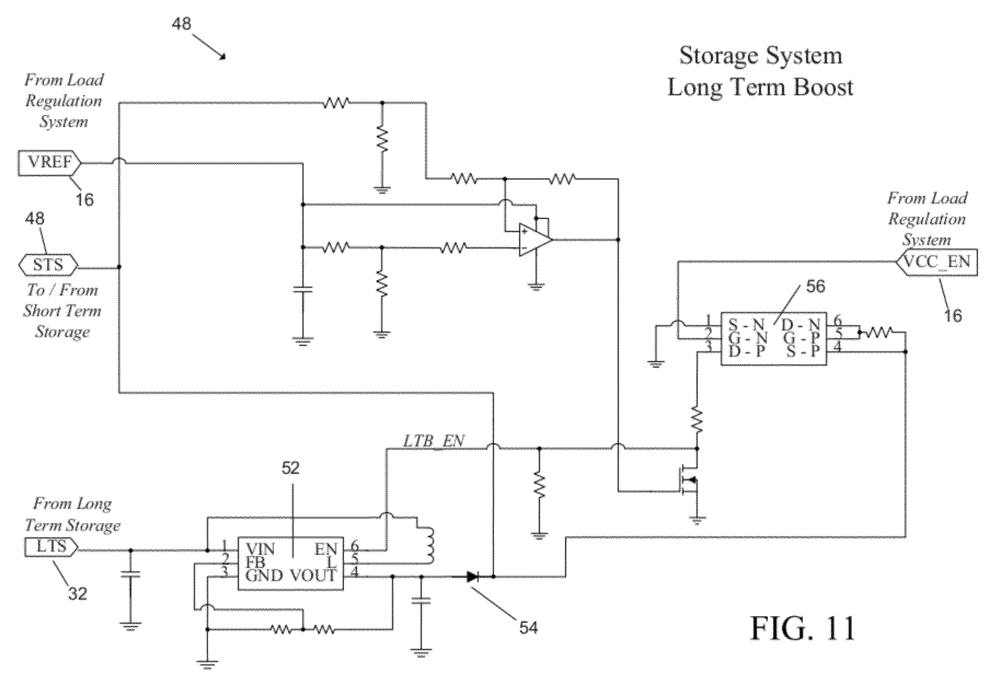

FIG. 12 is a circuit diagram of one embodiment of an output regulation and load control circuit usable in the load regulation system of FIG. 5.

### DETAILED DESCRIPTION OF THE INVENTION

A portable system for collecting energy in a wide variety of operating environments and storing that energy in a way that is both readily available and that provides for long term availability is provided. In one embodiment, the system 10 may be incorporated permanently into the electronic device for which power is required. In alternative embodiments, system 10 may be separable from the device to allow for interchangeability and the ability to power multiple devices depending on the user's priorities. System 10 may comprise an energy conversion system 12, an energy management and storage system 14, and a load regulation system 16. Energy is collected from a wide variety of sources, stored in a multi-stage capacitive storage system, and regulated to provide reliable power to one or more loads.

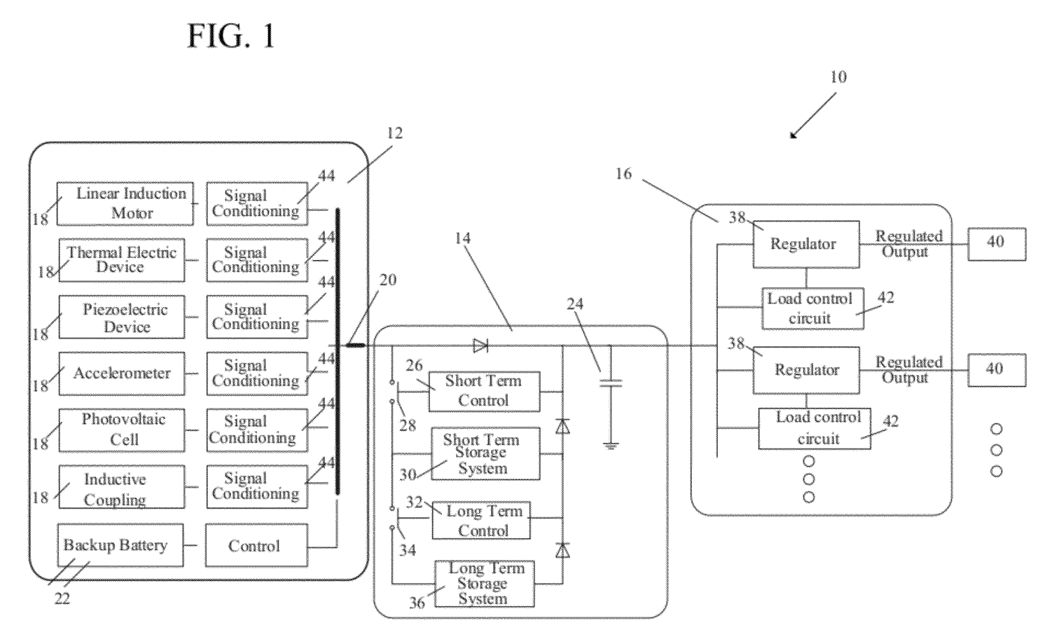

FIG. 1 is a block diagram of the energy scavenging power system 10 where the energy conversion system 12 charges the energy management and storage system 14, which in turn powers the load regulation system 16.

Energy Conversion System

The energy conversion system 12 is comprised of a suite of energy scavenging transducers 18 that are connected to a common charging bus 20. System 12 may incorporate one or more of the following types of transducers 18, including but not limited to: linear induction motors or generators, thermal electric devices, piezoelectric devices, pressure or strain harvesting devices, accelerometers, photovoltaic cells, inductive coupling devices, antennas, rectennas or other types of transducers. Additionally, system 10 may include one or more transducer 18 within each type of transducer. Each transducer 18 may harvest energy singularly or substantially simultaneously with one or more other transducers. Thus, system may be useful in a plurality of different environments or in an environment with changing conditions where multiple transducers may be helpful in scavenging energy.

A back-up battery 22 may be incorporated to provide additional or emergency power to the energy management and storage system 14 in order to ensure that power is available to the load. The common charging bus 20 provides power to the energy management and storage system 14.

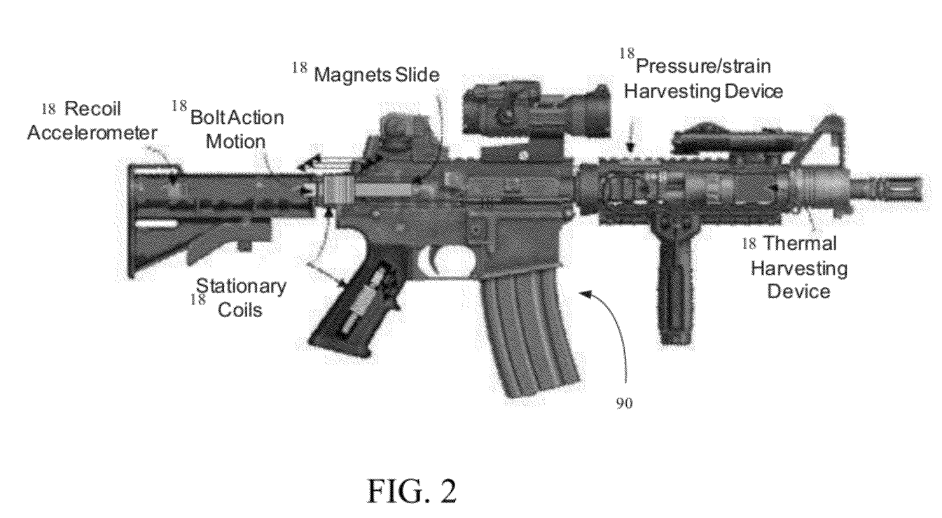

FIG. 2 shows a diagrammatical view of one exemplary application of the energy scavenging system 10, implemented in a weapons system 90. A number of energy scavenging transducers 18 are mounted in strategic locations on the weapon system 90 in order to scavenge the excess energy the weapon system 90 produces. In this application, e.g., it may be useful to measure wear on the weapon barrel in order to know when to retire or replace the barrel. Fatigue may depend on factors such as the number of rounds fired, whether rounds were fired individually or in rapid succession, etc. To measure these factors, one or more sensors may be desirable and may require power.

Weapons systems 90 may include other components requiring power, e.g., laser or night-vision sights, and energy scavenging system 10 may provide these components with at least some of the energy necessary to power them.

Additionally, energy scavenging system 10 may be applied to any structure or system that preferably is nondestructive and produces harvestable energy including, but not limited to, bridges—especially on pylons that may not have sufficient continuous solar exposure to rely solely on solar cells or may be inconvenient to reach—buildings, automobiles, naval vessels, aerial vehicles, and more. System 10 particularly may be well-suited for environments that are hazardous, e.g., areas with radiation exposure, or areas that are generally inaccessible or accessed only infrequently.

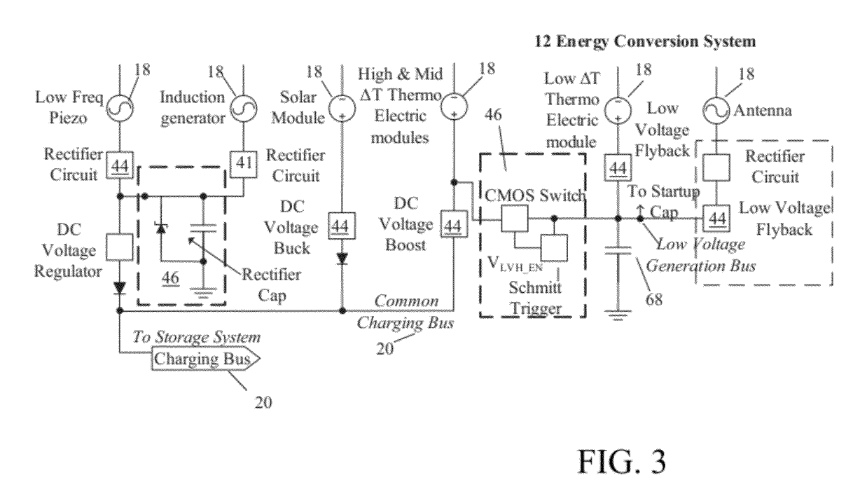

FIG. 3 is a schematic diagram of one embodiment of an energy conversion system 12. A plurality of energy scavenging transducers 18 are connected to respective appropriate signal conditioning circuits 44 that may vary depending upon the type of source. Signal conditioning circuits 44 may regulate the output of each transducer 18 to match the requirements of common charging bus 20. For example, a solar module transducer may be connected to a DC voltage buck, high and mid ΔT thermoelectric module transducers may be connected to a DC voltage boost, and a low ΔT thermoelectric module transducer may be connected to a low voltage flyback. Additionally, signal conditioning circuits 44 may include one or more rectifiers to convert AC current from certain transducers, e.g., piezoelectric devices, induction generators, and antennas, to DC current.

Signal conditioning circuits 44 may be selected or modified based on a choice of transducer 18 and/or mounting schemes.

Further supporting circuits 46 also may be necessary in order to provide a common regulated voltage to the common charging bus 20. Supporting circuits 46 may include, e.g., a low power generation bus 60, a low voltage harvest control or bus 62, and a high power bus 74, which may be considered conditioning circuits that are part of charging bus 20 and that condition signals to meet requirements of charging bus 20. Alternatively, supporting circuits 46 may be considered part of an overall system of signal conditioning leading into charging bus 20.

Charging bus 20 may be configured in several different ways. For example, a single charging bus 20 may tie together the conditioned output of each transducer 18. Alternatively, charging bus may include low power bus 60 that, in one configuration, ties low energy transducers 18 to start-up capacitor 24 only. In a second, preferred configuration, low power bus 60 may tie low energy transducers to both start-up capacitor 24 and one or more of short term storage system 30 and long term storage system 36. Additionally, charging bus 20 may include a low voltage bus 62 and a high power bus 74, and low voltage bus 62 may be a component of high power bus 74. Transducers 18 connected to low voltage bus 62 may be high power sources but may produce an output that requires a boost circuit to charge up the voltage enough to charge the storage systems 24, 30, 36. Thus, these high-power, low voltage transducers 18 may be connected together, boosted at low voltage bus 62, then tied to high power bus 74.

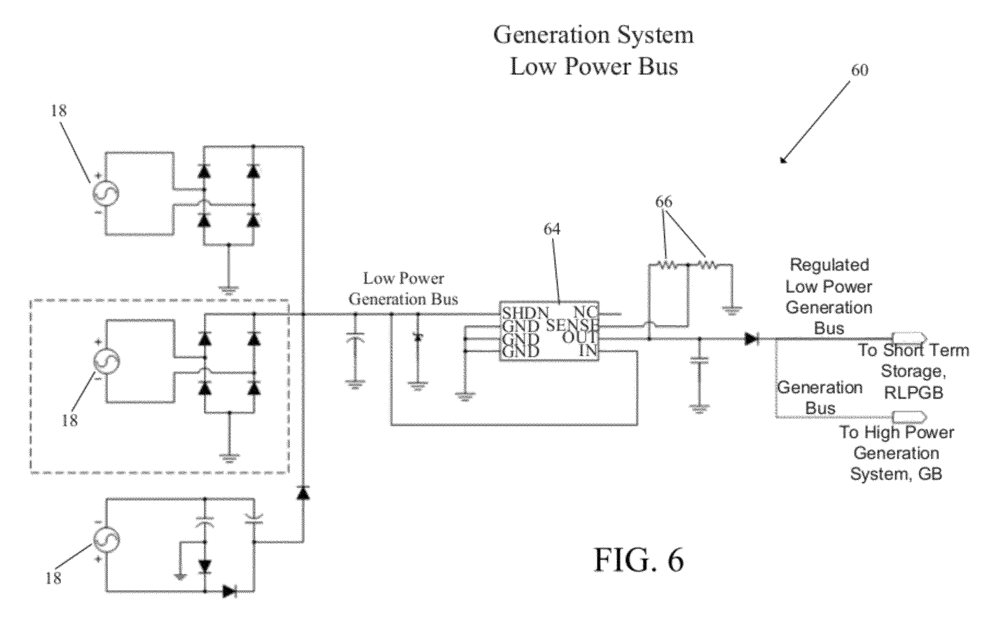

Turning to FIG. 6, one embodiment of low power generation bus 60 is shown. In low power generation bus 60, power from one or more transducers 18 may be combined and may be passed through a voltage regulator such as a low drop out linear regulator 64. Regulator 64 may be coupled to one or more resistors 66 whose resistance may be modified in order to achieve a desired output voltage. Once regulated, current may transmitted to short term storage and/or to a high power generation system. Low power generation bus 60 may receive energy from low power transducers 18 such as induction generators.

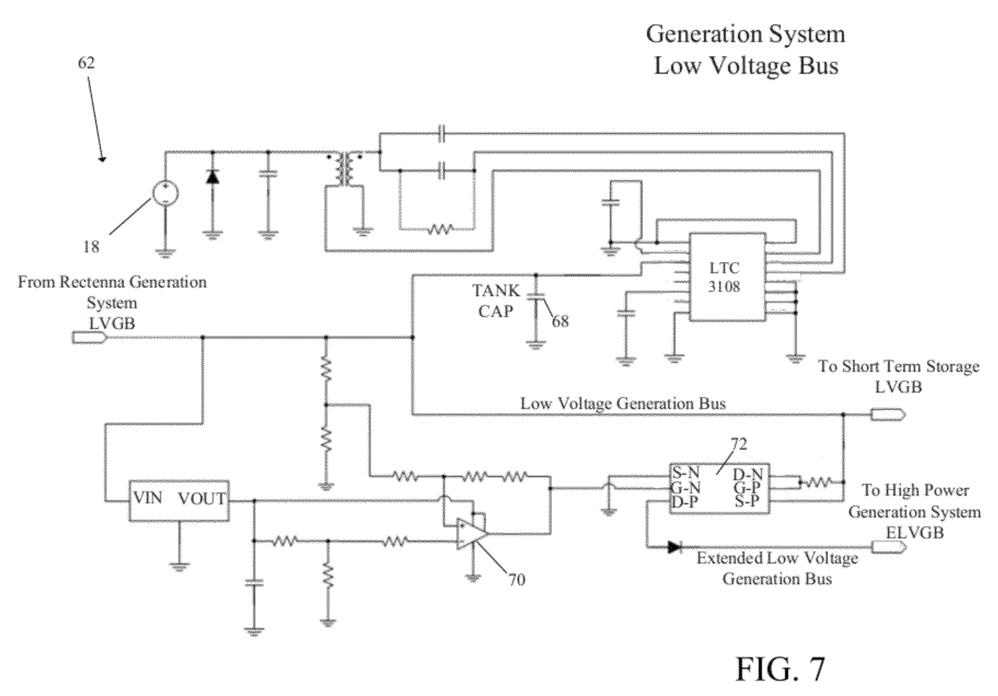

Turning to FIG. 7, one embodiment of a low voltage harvest or control bus 62 is depicted. In this embodiment, power received from one or more transducers 18 may be fed into a converter, e.g., an ultra-low voltage step-up converter. Low voltage bus 62 also may include a tank capacitor 68. While capacitance value for tank capacitor may vary, tank capacitor 68 preferably has a capacitance of about half that of start-up capacitor 24, e.g., if start-up capacitor 24 has a capacitance of about 2.2 mF, tank capacitor 68 may have capacitance of about 1 mF.

Internal Equivalent Series Resistance (ESR) of tank capacitor 68 preferably is chosen to be as close to 0 as possible, as larger ESRs may interfere with operation of low voltage harvest control circuit 62. A larger ESR in tank capacitor 68 may result in circuit 62 discharging prematurely. In one embodiment, tank capacitor 68 may be an AVX BZ055A333ZSB supercapacitor or other similar capacitor.

Low voltage bus 62 further may include a threshold circuit such as a Schmitt trigger 70, which may be electrically coupled to a switch 72 such as a CMOS. Trigger 70 may enable when stored voltage in tank capacitor 68 may reach a predetermined V_high level and disable when tank capacitor is at or below a predetermined V_low level.

Low voltage bus 62 further may include a MOSFET whose characteristics may be selected to allow for adequate voltage draining, e.g., certain PFETs may have a forward transconductance too low at a lower source to drain voltages. Additionally, certain PFETs may have an RDSon resistance of the lower gate-to-source voltages that is too high, which also may lead to switching problems. One example of a MOSFET suitable in low voltage bus 62 may be ON SEMICONDUCTOR's NTJD4105C.

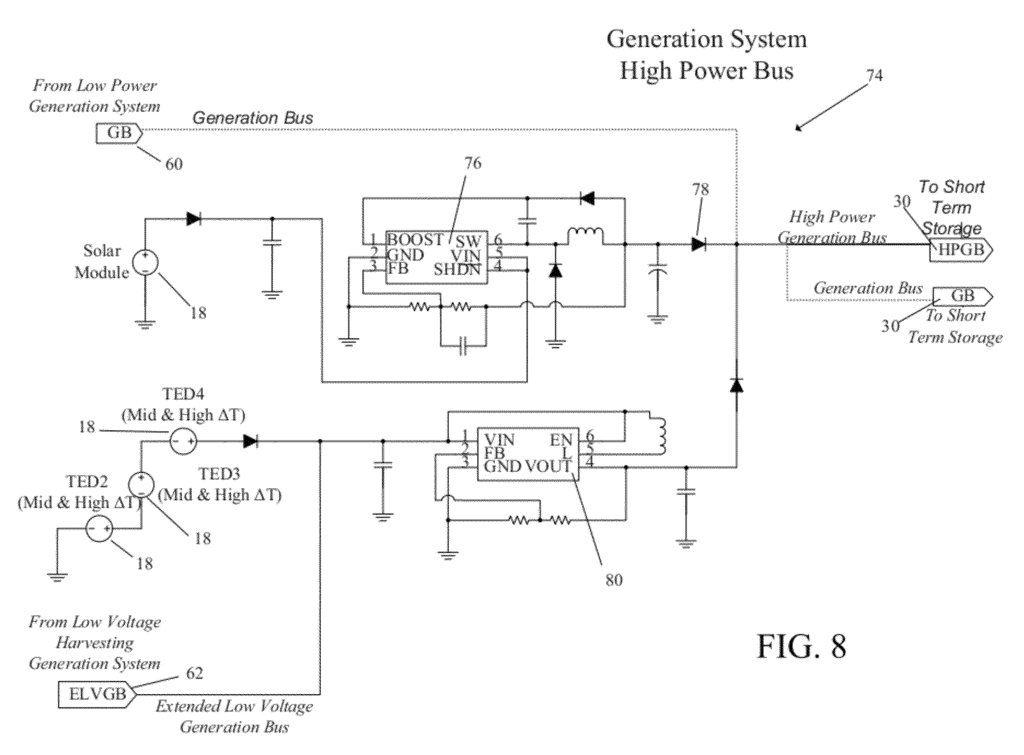

Turning now to FIG. 8, energy conversion system 12 further may include a high power bus 74 for transducers 18 such as solar modules and mid- and high ΔT thermoelectric modules. Solar module transducers may be electrically coupled to a signal conditioning circuit 44 such as a buck converter 76 or switching regulator, which may be designed or programmed to output a predetermined voltage. High power bus 74 may operate more efficiently if buck converter 76 or switching regulator is isolated, e.g., through use of blocking diode 78, although blocking diode preferably is selected to minimize leakage. For example, certain Schottky diodes may leak significant amounts of current back into buck converter, e.g., about 20 μA, which may be significant in lower power scavenging applications. One example of a blocking diode 78 usable in high power bus 74 may be a CDSU4148 from Comchip Technology Co.

High power bus 74 further may sum power obtained from thermoelectric module transducers and from low voltage harvest control 62 and pass them through a conditioning circuit, e.g., boosting them with DC/DC converter 80.

High power bus 74 then may combine power from comparatively high power transducers and possibly from low power generation system 60 and/or low voltage bus 62 to send to short term storage system 30, which may be part of the energy management and storage system 14, described below.

Energy Management and Storage System

The energy management and storage system 14 may comprise a multi-stage capacitive storage system managed by lower power control circuits configured to direct a flow of energy from stage to stage. Storage system 14 may be charged by common charging bus 20 and may utilize a plurality of storage stages.

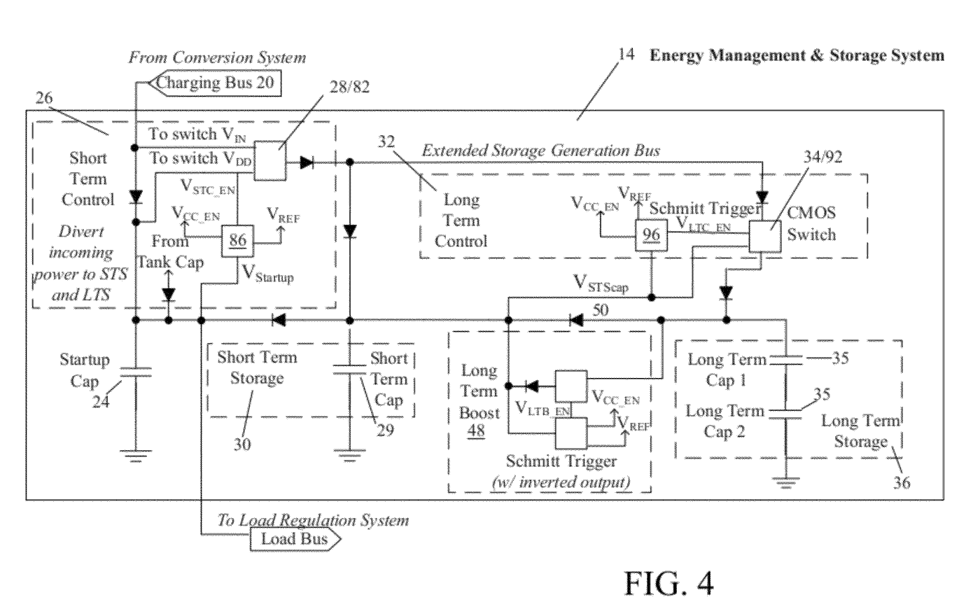

FIG. 4 is a schematic diagram of the energy management and storage system 14 shown in FIG. 1. Here, more details are shown to better explain how the short term control circuit 26 and long term control circuit 32 monitor the start-up capacitor 24 and short term capacitor 29, respectively, and how switches 28 and 34 are controlled to charge the short term storage 29 and long term storage 35.

Capacitance values may be selected and adjusted based on the application for which system 10 may be used. In an application such as the one shown in FIG. 2, start-up capacitor 24 may have a capacitance of about 1 mF, short term capacitor 29 may have a capacitance of about 50 mF, and long term capacitor 35 may have a capacitance of about 16½ F. In other applications, these values—individually or collectively—may vary by several orders of magnitude.

Energy management and storage system 14 may include one or more diodes 25, 31, 37. Diode 25 may allow current to flow from common charging bus 20 to start-up capacitor 24 but not vice versa. Similarly, diode 31 may allow charge to flow only in the direction from short term capacitor 29 to start-up capacitor 24, and diode 37 may allow charge to flow only from long term capacitor 35 to short term capacitor 29. It will be understood to one of ordinary skill in the art that diodes 25, 31, 37 may allow for a slight amount of leakage in a direction opposite to that intended, but that diodes 25, 31, 37 preferably are selected to minimize this leakage, as discussed below.

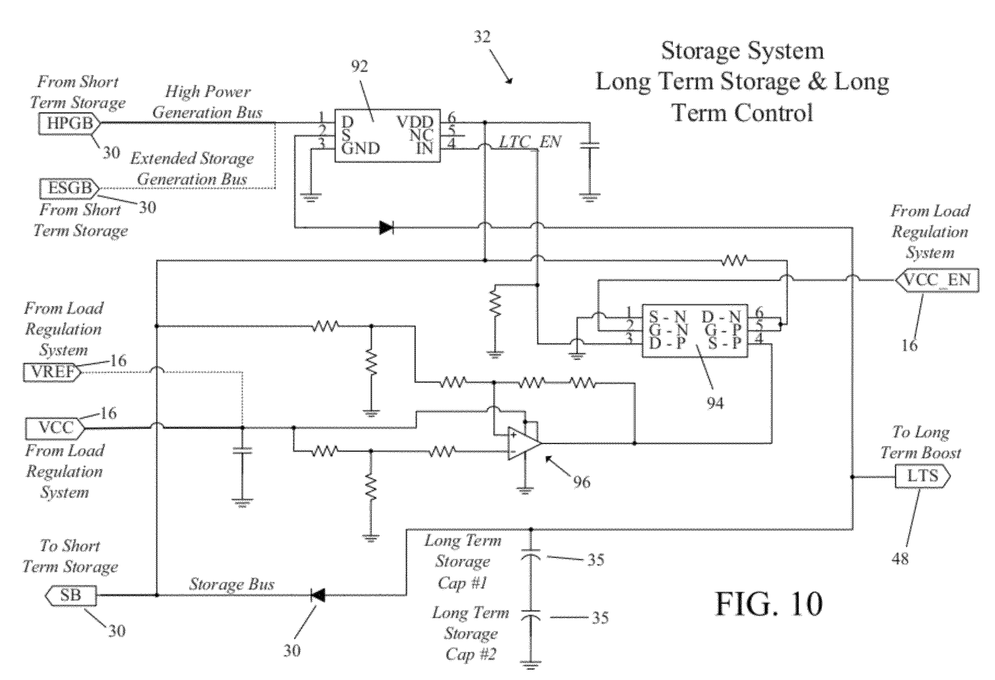

Isolation between various components may be significant in reducing current leakage. For instance, it may be important to maximize isolation between short term capacitor 29 and long term capacitor 35. In one embodiment, an STPS1L30MF Schottky diode from STMicroelectronics may be utilized for diode 37 between short and long term capacitors. However, this type of diode may leak as much as 20 μA from short term capacitor 29 back into the long term capacitor 35. In some applications, this application may be fairly negligible. Energy scavenging power system 10, however, may be useful in extreme-low power applications with small amounts of energy scavengeable from transducers 18, where 20 μA of leakage may be significant. For example, in the embodiment of FIG. 2, long term capacitor may have a self-discharge current of approximately 40 μA. Preferably, in these embodiments—although useful in other embodiments as well—a diode such as an MBRM011E Schottky diode from ON SEMICONDUCTOR may be utilized for diode 37 (seen in FIG. 10), since its leakage current may be only about 0.1 μA at room temperature.

In a preferred embodiment, storage system 14 may comprise capacitive storage banks including a start-up capacitor 24, a short term storage capacitor 29, and one or more long term storage capacitors 35. In this regard, “capacitor” may refer to a single capacitor or a bank of multiple capacitors. Additionally, the system may employ one or more inductors or nuclear batteries instead of capacitors, and description referring to capacitors should be understood to include inductors or nuclear batteries.

In another embodiment, storage system 14 may include two storage stages, e.g., only a short term storage capacitor 29 and a long term storage capacitor 35, which may provide sufficient power for system 10 but may require additional time to turn on. Alternatively, storage system 14 may include a start-up capacitor 24 and a short term storage capacitor, for which operational limits may be measured, e.g., in terms of hours rather than days.

In still another embodiment, storage system 14 may include even more storage stages, such as fourth, fifth, etc. stages. These stages may extend the operational limits by an even greater amount than in three-stage embodiment.

Start-up capacitor 24 may be a relatively small capacitor that may provide power quickly and directly to load regulation system 16, discussed below. Start-up capacitor 24 may receive charge from one or more system components, e.g., from both common charging bus 20 and short-term storage capacitor 29. Due to its relatively small size and storage capacity, start-up capacitor 24 preferably may be an electrolytic capacitor.

Short term capacitor 29 may be selected and sized to provide power to start-up capacitor 24 and/or load 40 for an intermediate length of time, e.g., between a few seconds and a few minutes. Short term capacitor 29 also may receive charge from one or more components, e.g., common charging bus 20 and long term storage capacitor 35.

Long term capacitor 35 may be selected and sized to provide power to short-term capacitor and/or load 40 for an extended length of time, e.g., several days. Long term capacitor 35 may receive charge from at least common charging bus 20.

Although similar capacitors may be used for short term capacitor 29 and long term capacitor 35, the choice of short term capacitor 29 may be determined by various considerations, including, e.g., cost, size/space, and temperature constraints. In one embodiment, such as the embodiment of FIG. 2 where space constraints may take precedence, short term capacitor 29 preferably may be a supercapacitor. In another embodiment, where space may not be as significant but lower cost or ability to operate at higher temperatures may dominate, short term capacitor 29 may be an electrolytic capacitor. In either case, the choice of short term capacitor 29 also may depend on the internal ESR of the capacitor, as a high ESR may interfere with operation of long term control circuit 32 by causing long term control circuit 32 to switch sporadically instead of staying on or off in a consistent, controlled manner. One possible type of short term capacitor 29 may be BZ015A503ZSB from AVX CORPORATION.

Conversely, long term capacitor 35 preferably may be a plurality of supercapacitors cascaded together, i.e., connected in series, as seen in FIG. 10. Supercapacitors may be more dense than electrolytic capacitors and, thus may be capable of storing a greater amount of energy, but there also may be a maximum voltage that can be put on supercapacitors, which may the reason for requiring a plurality of supercapacitors cascaded together.

In another embodiment, one or more rechargeable batteries may supplement or replace one or more capacitors, preferably one or more of long term capacitors 35. For example, thin film batteries may be a suitable replacement for capacitor 35. If rechargeable batteries are used, storage system 14 may include control circuitry to prevent batteries from discharging below their minimum operating voltage. One example of a thin film battery that may work in storage system 14 may be THINERGY's MEC102, although other batteries may be suitable.

Short term capacitor 29 and/or long term capacitor 35 may be unnecessary, e.g., in energy rich environments where transducers may collect sufficient energy to substantially power load 40 as needed. In this case, system 10 still may include short and long term capacitors, but they may function substantially as energy reservoirs.

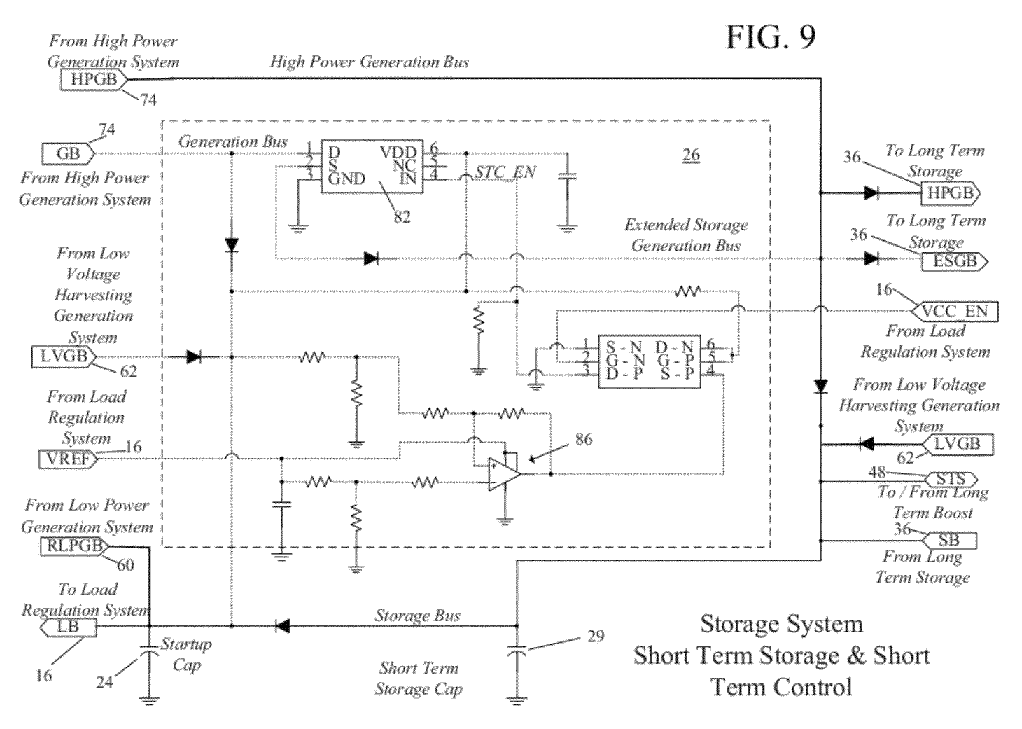

Turning to FIG. 9, one example of a short term control circuit 26 electrically coupled to start-up capacitor 24 and short term capacitor 29 is provided. Short term control circuit 26 may receive energy from common charging bus, i.e., from low power generation bus 60, low voltage harvest control/bus 62, and high power bus 74. The solid-line perimeter of the circuit diagram of FIG. 9 may form one possible routing for energy through short term control circuit 26.

Alternatively, the broken line connections in the interior of FIG. 9 may represent an alternative or additional possible routing. In this second routing, circuit 26 may include one or more switches, such as CMOS switch 82 or small signal MOSFET 84. Switch 82 may correspond to switch 34 that controls flow of energy into/out of start-up capacitor 24 and short term capacitor 29.

As with switch 72 in low voltage bus 62, MOSFET 84 may be selected to allow for adequate voltage draining, e.g., certain PFETs may have a forward transconductance too low at a lower source to drain voltages. One example of a MOSFET suitable for switch 84 may be ON SEMICONDUCTOR's NTJD4105C. This switch 84 may prevent the system from drifting to an on position while charging and before being charged sufficiently.

Short term control circuit 26 also may include circuits for making control decisions. In one embodiment, this means that short term control circuit may include a microcontroller or comparator circuit. Preferably, however, short term control circuit 26 may include a Schmitt trigger 86, which may be better suited for making control decisions in very low power environments than microcontrollers, which may require additional current to operate. Schmitt trigger 86 also may be preferred over a comparator circuit, since Schmitt trigger may be used to build a hysteresis into the system.

Energy Management and Storage System 14 allows power to flow to the start-up capacitor 24 which is monitored by a short term control circuit 26. Short term control circuit 26 may close a switch 28 when the start-up capacitor 24 reaches a predetermined charge threshold and allow power to flow to the short term storage system 30 from common charging bus 20. In one embodiment, short term control circuit 26 may divert energy to short term storage system 30 when start-up capacitor 24 is substantially fully charged.

The short term storage system 30, in turn, may be monitored by the long term control circuit 32, examples of which may be seen in FIGS. 4 & 10. The long term circuit 32 may close a switch 34 when the short term capacitor 29 reaches a predetermined charge threshold and allow power to flow into the long term capacitor 35 from common charging bus 20.

As with short term control circuit 26, switch 34 in long term control circuit 32 may correspond to CMOS switch 92. A suitable example may be ANALOG DEVICES' ADG801 monolithic CMOS single-pole, single throw switch.

MOSFET 94 may be selected to allow for adequate voltage draining, and one example of a MOSFET suitable for switch 94 may be ON SEMICONDUCTOR's NTJD4105C. This switch 84 may prevent the system from drifting to an on position while charging and before being charged sufficiently.

Like short term control circuit 26, long term control circuit 32 also may include circuits for making control decisions, e.g., a microcontroller or comparator circuit. Preferably, however, long term control circuit 32 may include a Schmitt trigger 96. Additionally, Schmitt trigger 96 preferably is powered substantially continuously. Thus, Schmitt triggers with lower current draws are preferred, e.g., INTERSIL's ISL28194 trigger may be used, since its current draw may be about 330 nA.

Long term control circuit 32 may include a hysteresis to prevent circuit from having the same turn on and turn off voltage points, e.g., Schmitt trigger 96 may include a programmable hysteresis around its internal threshold voltage. Preferably, hysteresis includes a turn on voltage substantially higher than the threshold voltage and a turn off voltage substantially below the threshold voltage. For example, short term capacitor 29 preferably maintains a threshold voltage of at least about 4.25 V, but may be charge up to about 5 V. As such, long term control circuit 32 may allow short term capacitor 29 to charge up to about 5 V and then divert energy from charging/generation bus 20 to long term capacitor 35 in long term storage system 36. If voltage on short term capacitor 29 drops below threshold voltage, i.e., here about 4.25 V, both charging bus 20 and long term capacitor 35 may revert to charging short term capacitor 29. Additionally, hysteresis may not be confined to long term control circuit 32 but also may apply to one or more of short term control circuit, 26, long term boost circuit 48, and load control circuit 42.

In one embodiment, long term control circuit 32 may divert energy to long term storage capacitor 35 when short term capacitor 29 is substantially fully charged. Long term capacitor 35 may charge until substantially fully charged, e.g., about 95% charged, although it may continue to trickle charge for a substantial period of time after reaching this point. System 10 preferably includes a sufficient number and type of transducers 18 to allow long term capacitor 35 to charge substantially fully within a predetermined period of time, e.g., about one hour in one embodiment.

Conversely, if the charge on start-up capacitor 24 drops below a predetermined value while charging bus 20 is charging either short term capacitor 29 or long term capacitor 35, charging bus 20 may redirect flow of energy from transducers away from short term capacitor 29 or long term capacitor 35 and into start-up capacitor 24. In this event, start-up capacitor 24 also may receive power from short term capacitor 29. Additionally, short term storage system 30 may receive power from long term storage system 36.

Similarly, if start-up capacitor 24 has adequate charge but charge on short term capacitor 29 drops below a predetermined value while charging bus 20 is charging long term capacitor 35, charging bus 20 may redirect flow of energy from transducers away from long term capacitor 35 and into short term capacitor 29. Short term capacitor 29 also may receive power from long term capacitor 35 while receiving power from charging bus 20.

Turning to FIGS. 4 & 11, energy management and storage system 14 further may include a long term boost circuit 48. Long term boost circuit 48 may utilize long term capacitor 35 as an energy source to recharge the short term capacitor 29 when the voltage of the long term capacitor 35 is too low to naturally flow through the isolation diode 50 into the short term storage system 30. Energy from long term capacitor 35 may flow into voltage regulator or converter 52. In this manner, the long term boost circuit 48 acts as a voltage pump to recharge the short term storage system 30 to ensure that nearly all the energy stored in the long term storage system 36 is utilized, regardless of its voltage level.

Voltage regulator 52 should allow for voltage boosting while avoiding the sinking of excessive current, which may prevent long term capacitor 35 from charging. One potential solution to this situation may be to use an isolation diode 54 between regulator 52 and other system components, such as short term capacitor 29.

Like short term control circuit 26 and long term control circuit 32, long term boost circuit 48 may include a switch 56 such as a small signal MOSFET to allow for adequate voltage draining, and one example of a MOSFET suitable for switch 56 may be ON SEMICONDUCTOR's NTJD4105C. This switch 56 may prevent the system from drifting to an on position while charging and before being charged sufficiently.

Load Regulation System

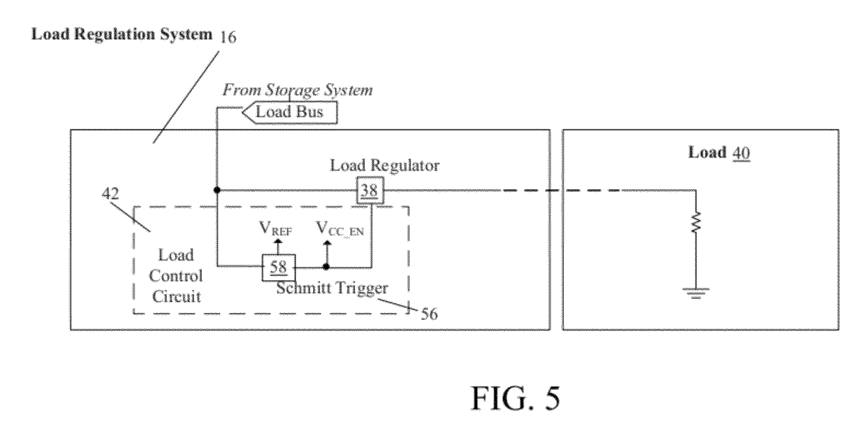

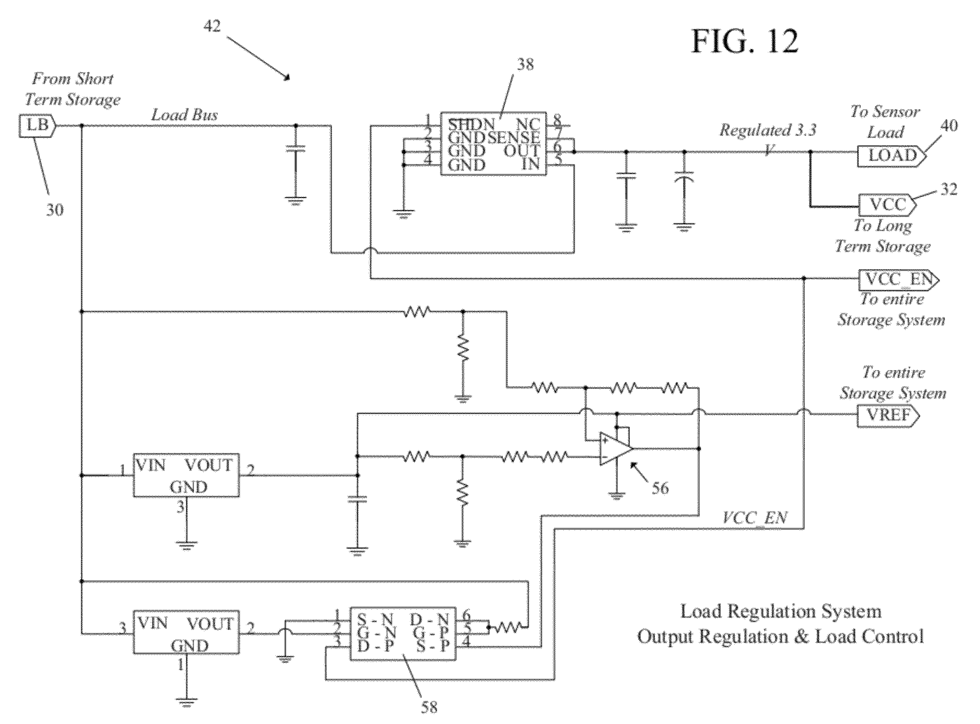

FIGS. 5 and 12 are schematic diagrams of the load regulation system 16 shown in FIG. 1. Here, load control circuit 42 monitors the voltage on the start-up capacitor 24 and when it reaches a predetermined high-level turns on the load regulator 38. The load control circuit 42 will allow the start-up capacitor 24 to be discharged to a predetermined low-level and then turns the load regulator 38 off. As such, power will only be supplied to the load 40 if there is enough energy stored in the energy management and storage system 14 to power the load sufficiently.

Load control circuit 42 may utilize hysteresis to ensure that power is not delivered to the load 40 if energy in system 10 is insufficient to power load 40. As with short and long term control circuits, load control circuit 42 may include a microcontroller, a comparator or, preferably, a Schmitt trigger 56 to make control decisions. Schmitt trigger 56 preferably has a hysteresis large enough to comply with predetermined requirements. One example of a Schmitt trigger usable with load control circuit may include an op amp from INTERSIL, model ISL28194.

Load control circuit 42 also may include one or more switches, such as a small signal MOSFET 58. MOSFET 58 may be selected to allow for adequate voltage draining, e.g., certain PFETs may have a forward transconductance too low at a lower source to drain voltages. One example of a suitable MOSFET may be ON SEMICONDUCTOR's NTJD4105C.

Additionally, multiple loads and corresponding regulators may be cascaded or connected in parallel at the output of the start-up capacitor 24.

The system may provide an energy source used to power one or more small electronic loads, such as sensors. In many cases, the amount of energy to scavenge may be fairly minimal, e.g., on the order of hundreds of microwatts to a few watts. Sensors may be of a type that are functional with this minimal power supply, using only a small amount of energy so that energy management and storage system 14, once charged fully, may be able to power loads for an extended period of time. For example, in the weapons system embodiment of FIG. 2, a fatigue odometer may have a typical power consumption of about 90 miliwatts.

Due to the relatively small amounts of power that may be scavenged in typical implementations using system 10, the specific choice and characteristics of components may be significant, e.g., as discussed throughout, components may be selected to interface well within system 10 and to minimize power draw.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. An energy scavenging power system, comprising:
an energy conversion system having at least one transducer configured to harvest energy;
an energy management and storage system configured to store said harvested energy; and
a load regulation system configured to provide said stored energy to power one or more loads;
wherein said energy management and storage system comprises a start-up capacitor, a short term capacitor and a long term capacitor, said short term capacitor having a larger capacitance than said start-up capacitor and said long term capacitor having a larger capacitance than said short term capacitor.

2. An energy scavenging power system according to claim 1, further comprising a charging bus electrically coupled to said energy conversion system and said energy management and storage system, said charging bus providing energy to said energy management and storage system.

3. An energy scavenging system according to claim 2, said charging bus including at least one of a low power bus, a low voltage bus, and a high power bus.

4. An energy scavenging system according to claim 2, wherein each transducer is electrically coupled to a signal conditioning circuit, said signal conditioning circuit regulating an output from said transducer to match a requirement for said charging bus.

5. An energy scavenging system according to claim 2, said energy management and storage system comprising a plurality of control circuits configured to direct energy from said charging bus to said start-up capacitor, said short term capacitor or said long term capacitor based on a predetermined rule set.

6. An energy scavenging system according to claim 2, wherein said start-up capacitor is charged directly by said short term capacitor and said charging bus.

7. An energy scavenging system according to claim 2, wherein said short term capacitor is charged directly by said long term capacitor and said charging bus.

8. An energy scavenging system according to claim 2, wherein said long term capacitor is charged directly by said charging bus.

9. An energy scavenging system according to claim 1, wherein said at least one transducer is selected from the group comprising: linear induction motors, thermal electric devices, piezoelectric devices, pressure harvesting devices, strain harvesting devices, accelerometers, photovoltaic cells, inductive coupling devices, antennas, and rectennas.

10. An energy scavenging system according to claim 1, further comprising a plurality of types of transducers selected from the group comprising: linear induction motors, thermal electric devices, piezoelectric devices, pressure harvesting devices, strain harvesting devices, accelerometers, photovoltaic cells, inductive coupling devices, antennas, and rectennas.

11. A low power energy scavenging system, comprising:
a plurality of transducers configured to scavenge energy from one or more sources;
a plurality of charging stages, each stage comprising at least one capacitor and at least one switching circuit; and
a charging bus configured to receive energy from said plurality of transducers and route said energy to said plurality of charging stages;
wherein only one charging stage at a time receives energy from said charging bus;
wherein each switching circuit includes a hysteresis to establish different turn on and turn off voltage points for said switching circuit; and
wherein said system is configured to provide power to one or more low power consumption loads.

12. A low power energy scavenging system according to claim 11, at least one switching circuit including a Schmitt trigger.

13. A low power energy scavenging system according to claim 11, said plurality of charging stages including a start-up stage, a short term stage, and a long term stage.

14. A low power energy scavenging system according to claim 13, wherein said start-up stage includes a first capacitor comprising an electrolytic capacitor, said short term stage includes a second capacitor comprising an electrolytic capacitor or a supercapacitor, and said long term stage includes a third capacitor comprising at least one supercapacitor;
wherein said first capacitor has a capacitance lower than a capacitance of said second capacitor; and
wherein said second capacitor capacitance is lower than a capacitance of said third capacitor.

15. A low power energy scavenging system according to claim 14, wherein said third capacitor comprises a plurality of capacitors connected in parallel.

16. A process for scavenging and distributing small amounts of energy to one or more loads, comprising:
harvesting energy using a plurality of transducers;
conditioning said harvested energy to substantially match input requirements for a charging bus; and
distributing energy from said charging bus to a start-up capacitor, a short term capacitor, and a long term capacitor;
wherein said start-up capacitor is charged until substantially fully charged;
wherein said short term capacitor is charged until either substantially fully charged or until a charge level of said start-up capacitor drops below a predetermined value; and
wherein said long term capacitor is charged until either substantially fully charged or until said start-up capacitor charge level drops below said predetermined value or until a charge level of said short term capacitor drops below a second predetermined value.

17. A process according to claim 16, wherein said distributing step comprises:
charging said start-up capacitor with energy from said charging bus and said short term capacitor;
charging said short term capacitor with energy from said charging bus and said long term capacitor; and
charging said long term capacitor with energy from said charging bus.

18. A process according to claim 16, wherein said a capacitance of said short term capacitor is at least an order of magnitude larger than a capacitance of said start-up capacitor, and further wherein a capacitance of said long term capacitor is at least two orders of magnitude larger than said short term capacitor capacitance.

19. A process according to claim 16, further comprising:
switching said start-up capacitor, said short term capacitor, and said long term capacitor on and off depending on predetermined voltage levels; and
evaluating a hysteresis at one or more of said start-up capacitor, said short term capacitor, and said long term capacitor to determine whether each capacitor is charging or discharging.

20. A process according to claim 19, wherein said switching and said evaluating steps are accomplished using a separate switching circuit for each of said start-up capacitor, said short term capacitor and said long term capacitor, wherein at least one of said switching circuits includes a Schmitt trigger.
